(19) United States
(12) Patent Application Publication
(10) Pub. No.: US 2022/0327112 A1
(43) Pub. Date: Oct. 13, 2022

(54) Smart Contracts for Assessing Truth on a Blockchain

(71) Applicant: Frederick Roth, San Jose, CA (US)

(72) Inventor: Frederick Roth, San Jose, CA (US)

(73) Assignee: Transactable Corporation, Foster City, CA (US)

(21) Appl. No.: 17/808,304

(22) Filed: Jun. 23, 2022

Related U.S. Application Data
(63) Continuation-in-part of application No. 16/682,974, filed on Nov. 13, 2019, now Pat. No. 11,397,777.

(51) Int. Cl. G06F 16/23; G06F 16/955; G06F 16/9536

(52) U.S. Cl. CPC G06F 16/2379; G06F 16/955; G06F 16/9536

(57) ABSTRACT

Disclosed is a system and method for associating endorsers with articles on by querying a smart contract on a blockchain. The invention establishes an assessor account for an assessor in an assessment database. The assessor account includes assessment attributes of an assessor. An article record is established for an article in the smart contract on a blockchain. The article record includes a URI, an article status from said assessor, and an association between the article record and the assessor account. The system responds to a request from an article viewer in which the request includes the URI of the article by querying the smart contract, determining if the URI supplied is associated with an article record, and if so, returning to the article viewer a response that includes the article status.

### CROSS-REFERENCE TO RELATED APPLICATIONS

The present application is a continuation-in-part, and claims the benefit, of U.S. application Ser. No. 16/682,974, filed on Nov. 13, 2019, titled Systems and Method for Associating Endorsers with Articles on the Internet, which is incorporated by reference.

### FEDERALLY SPONSORED RESEARCH

Not applicable.

### SEQUENCE LISTING OR PROGRAM

Not applicable.

### FIELD OF INVENTION

The present invention relates to computer implemented systems for associating attributes to articles on a blockchain.

### BACKGROUND OF THE INVENTION

The world is awash in information, and much of it should not be trusted for any one of a number of reasons. Humanity depends on four critical elements for survival: 1) breathable air, 2) potable water; 3) edible food; and 4) truthful information. While nations of the world have recognized the importance of protecting air, water and food, pollution of the information environment has been allowed to proliferate largely unchecked. The consequence is a diminished trust in public dialogue resulting in part from 1) flagrant deception; 2) manipulation; 3) partisan and polarizing ideologies; 4) lack of sanctions, either positive or negative; and 4) learned helplessness.

The Internet and public media have become increasingly polluted with lies and disinformation. Russia, China, North Korea and other actors, have weaponized fake information by targeting it to people who have no easy way to avoid it. People now realize how manipulators use Twitter and Facebook to generate thousands of lies that bombard millions immediately and repetitively. The amount of deceptive information has grown exponentially. The glut of toxic media has a chilling effect on social discourse as people tune out to escape. Many people have stopped following the news and social media.

Readers and viewers have no way to filter the bogus information from the rest, so they must wade through increasingly large volumes of chaff to find, if they are lucky, the kernels of truth. Anybody can get an online account, using whatever name they choose, and they are free to spew information pollution. Moreover, weaponized disinformation campaigns procure millions of robotic accounts and use these to generate, repeat, and favor their own chosen phony memes. Millions of bots and paid posters create false and deceptive content. Consumers are misled, and the content of reputable authors and publishers is subject to doubt.

Several services exist for the purpose of distinguishing factual statements from incorrect statements and misrepresentations.

JustFacts researches and publishes verifiable facts about the leading public policy issues through the use of a Standards Of Credibility to determine what constitutes a credible fact and what does not. The Standards Of Credibility comprise the following attributes: 1) Facts: facts are presented as plain as possible and use language that is clear and precise; 2) Excluded Facts: “facts” excluded are those that are rendered pointless by other facts and those that do not otherwise meet the Standards of Credibility; 3) Accuracy: sources are not used uncritically, and research contains footnotes with direct quotes and/or raw data from the cited sources; 4) Estimates and Minor Discrepancies: these are handled by giving preferentiality to figures that are contrary to their viewpoints and by using the most cautious plausible interpretations of such data; 5) Conclusions and Quotes: quotes are kept within context, conclusions and quotes made by people with vested interests are excluded except to point out inconsistencies and hypocrisy; 6) Incomplete Data: “facts” that do not account for vital contextual information are not included in research; 7) Balance: the goal is comprehensive accuracy as opposed to balance since the goal is to publish verifiable facts regardless of the views they support, not to circulate half-truths and propaganda. However, JustFacts does not allow third parties to initiate a topic, does not provide a market based mechanism for sourcing and validating information, and there is limited negative impact to purveyors of falsehoods.

Factcheck.org is a nonpartisan, nonprofit “consumer advocate” for voters that aims to reduce the level of deception and confusion in U.S. politics. Factcheck.org monitors the factual accuracy of what is said by major U.S. political players in the form of TV ads, debates, speeches, interviews and news releases. Their stated goal is to apply the best practices of both journalism and scholarship, and to increase public knowledge and understanding.

U.S. patent application Ser. No. 13/066,038 to Hayes-Roth provides for a truth-seal affixing system that creates and provides a computer-renderable instance of a truth-seal annotation schema for a truth-seal to be affixed to a digital statement within a digital document. The truth-seal annotation schema instance contains truth-seal values for rendering and displaying the truth-seal of the digital statement within the digital document allowing readers when viewing the digital document to: (i) identify the existence of the truth-seal, and (ii) request or determine truth-seal values of the truth-seal. The truth-seal affixing system further accesses and interprets instances of a truth-seal annotation schema for any affixed truth-seals. A computer program analyses the truth-seals of digital statements of all digital documents in a set to generate a computer accessible output: (i) identifying the existence of truth-seals, and (ii) extracting one or more of truth-seal values of any truth-seals affixed to each of the documents in the set. While this invention does provide a market-based mechanism for ensuring integrity of public statements, it does not address associating endorsers of a statement or article with a mechanism for determining and displaying the reputation of the endorser.

The media platforms of today have little incentive to bar phony authors and their bogus posts. These platforms measure success in terms of total time human eyeballs are exposed to their content, even when most or all of it misleads and misinforms. As a consequence, thoughtful people do not trust the Internet and popular media. Increasingly, people find media aversive and they want an escape. What is needed is a system to allow consumers to filter out all information from mistrusted sources automatically.

What is needed is an efficient way to filter out false and anonymous information so the remaining articles can be trusted. What is needed is a system that makes it easy for real, honest people to create and endorse factual articles, and then filter out bogus information so it never reaches readers who opt for filtering. What is needed is an automated and scalable authentication solution that verifies the identity of producers and endorsement of their fact-checking processes to enhance their reputations and the trustworthiness of their content. Every author in the improved system is a known human being or publisher who commits to honesty in publishing.

There are several ways to implement a filter for trusted sources. One way is to use a browser plug-in. Once a user installs the plug-in to their browser, they can opt to filter out mistrusted sources automatically. This enables users to consume only content from trusted sources. Reputable publishers can be enabled to add these optional filtering capabilities to their apps as well. An ability to filter content by trustworthiness should make every platform more valuable.

Additionally, it would be beneficial for endorsers to create successive revisions to articles that rely upon the trustworthiness credentials of the endorsers and allow consumers of articles to know who has endorsed them and to view their trustworthiness credentials. The system and method permit challenges to inaccuracies in an article that alter the trustworthiness of an article and its endorser. Inaccuracies can be traced to earlier versions of an article and thus retract the validity of all subsequent versions derived from any of those earlier versions. Human or machine agents can perform the tracing of inaccuracies. In some cases, the cause of the inaccuracy may reveal a conceptual error in an earlier article that leads to an improved, more accurate article based on a more accurate concept. In some cases, the error may reflect a logical or factual mistake. When many informed and trustworthy users participate in growing and refining such trusted article trees, the collection of trees becomes the most valid representation of community knowledge. Unlike AI experimental truth maintenance systems, trusted article trees do not require machine interpretable representations of knowledge nor do they depend upon AI algorithms to diagnose errors and infer knowledge refinements. Trusted article trees provide the first general-purpose solution to represent and share valid general knowledge.

An approach for generating new knowledge when it is discovered that evidence has contradicted some logically sound prediction has been described in Hayes-Roth F. (1983) Using Proofs and Refutations to Learn from Experience. In: Michalski R. S., Carbonell J. G., Mitchell T. M. (eds) Machine Learning. Symbolic Computation. Although this seems impossible, the authors argue that this occurs often and offers an opportunity to discover new knowledge. The basic idea is that the incorrect prediction arises from an overly general inferential rule. The problems are eliminated by identifying two subclasses of situations, one for which the original inferences remain valid and another that produces valid results for the new subclass that contains the situation that refuted the original inference. This work almost always requires human intelligence and cannot reasonably be automated for most areas of knowledge, That motivates the present invention to provide tools for human knowledge, inference, and knowledge refinement.

A report describing a research program to help accelerate the acquisition of knowledge by machines that can also modify the knowledge in response to experience is outlined in Hayes-Roth, F., Klahr, P. and Mostow, D. J. J., “Knowledge acquisition, knowledge programming, and knowledge refinement”, Technical Report R-2540-NSF, The Rand Corporation, May 1980. The results are highly limited because so little human knowledge can be represented and manipulated automatically. Human skills at reading, understanding, and knowledge refinement seem required in the vast majority of cases. That motivates the present invention to provide tools for human knowledge, inference, and knowledge refinement.

Dynin (U.S. Pat. No. 9,177,063) explains how a group of people can identify articles they think best meet search requirements of others in the group. In contrast, the embodiments of the present invention describe how to author trusted modules and, through one-at-a-time increments, author documents comprising many trusted components. The advantages of embodiments of the present invention are that they could provide a means for constructing a trusted and reliable body of knowledge, but permitting readers to challenge and refute an article based explicitly on one edit, attributable to one author, whenever a newly published version manifests an error. Embodiments of the present invention would permit the construction of a reliable knowledge base, based on the winnowing of error-prone authors and their mistakes.

Myslinkski (U.S. Pat. No. 10,614,112) explains how to fact-check content by automatically identifying contained claims and comparing them to trusted reference data. In contrast, embodiment of the present invention provide means for authors to create any kind of document and to warrant its credibility. Every document is constructed by an author and incorporates a plurality of previously constructed and warranted components. In this way, complex structures can be assembled by any author, and the validity of the total is warranted by that author. Unlike Wikipedia that allows many authors to modify the same document, embodiments of the present invention make the latest version of any document the sole responsibility of the most recent editor or author. The advantages of this are that it allows for any type of content or claim, whether or not machine understandable. Since the vast majority of human knowledge is not machine understandable, the present invention addresses a great variety of possibilities.

Bates et al (US Publication 2008/0301802) explains how link navigation between documents can be improved by blocking paths leading to distrusted articles. Embodiments of the present invention address how best to construct trusted articles from trusted components and how to change the trustworthiness assessment of any article comprising formerly trusted components that become distrusted. The advantage of embodiment of the present invention is that is provides means for constructing and sharing compound documents whose trustworthiness depends on the trustworthiness of the author's edits as well as the trustworthiness of any components the author includes. Moreover, when any article becomes distrusted, embodiments of the present invention describe how the affected trustworthiness assessments of all containing documents must be altered from trusted to unknown (meaning unassessed).

One of the benefits of the present invention is that it makes possible the growth, maintenance, and consumption of human-interpretable articles of knowledge. A further benefit is that the network can also be used, in special circumstances, to allow trusted machine agents to endorse articles. A trusted article tree therefore provides a foundation for all knowledge.

A blockchain is a growing list of records, called blocks, that are securely linked together using cryptography. Each block contains a cryptographic hash of the previous block, a timestamp, and transaction data (generally represented as a Merkle tree, where data nodes are represented by leafs). The timestamp proves that the transaction data existed when the block was published to get into its hash. As blocks each contain information about the block previous to it, they form a chain, with each additional block reinforcing the ones before it. Therefore, blockchains are resistant to modification of their data because once recorded, the data in any given block cannot be altered retroactively without altering all subsequent blocks.

Blockchains are typically managed by a peer-to-peer network for use as a publicly distributed ledger, where nodes collectively adhere to a protocol to communicate and validate new blocks. Although blockchain records are not unalterable as forks are possible, blockchains may be considered secure by design and exemplify a distributed computing system with high Byzantine fault tolerance.

Smart contracts are simply programs stored on a blockchain that run when predetermined conditions are met. They typically are used to automate the execution of an agreement so that all participants can be immediately certain of the outcome, without any intermediary's involvement or time loss. They can also automate a workflow, triggering the next action when conditions are met.

The objectives of smart contracts are the reduction of need in trusted intermediators, arbitrations and enforcement costs, fraud losses, as well as the reduction of malicious and accidental exceptions.

Similar to a transfer of value on a blockchain, deployment of a smart contract on a blockchain occurs by sending a transaction from a wallet for the blockchain. The transaction includes the compiled code for the smart contract as well as a special receiver address. That transaction must then be included in a block that is added to the blockchain, at which point the smart contract's code will execute to establish the initial state of the smart contract. Byzantine fault-tolerant algorithms secure the smart contract in a decentralized way from attempts to tamper with it. Once a smart contract is deployed, it cannot be updated. Smart contracts on a blockchain can store arbitrary state and execute arbitrary computations. End clients interact with a smart contract through transactions. Such transactions with a smart contract can invoke other smart contracts. These transactions might result in changing the state and sending coins from one smart contract to another or from one account to another.

The most popular blockchain for running smart contracts is Ethereum. On Ethereum, smart contracts are typically written in a Turing-complete programming language called Solidity, and compiled into low-level bytecode to be executed by the Ethereum Virtual Machine.

It would be beneficial to for a system to associates an Endorser with an article, allow viewers of the article to determine the identity of the Endorser and the reputation of the Endorser with such information distributed on a cryptographically secure and immutable blockchain.

### SUMMARY OF THE INVENTION

### Definitions

“Adjudication process” means a process of verifying or denying the article status of an article when the article status has been initially set to mistrusted by an assessor.

“Article” means content conveying information, which may comprise written material, images, video, or other communicative information distributed on the Internet.

“Article status” means the state of article, which may be either trusted, unknown, or mistrusted. An article status of trusted or mistrusted means that the article has been assessed by an assessor. An article status of unknown means that the article has not been assessed by an assessor.

“Article viewer” means an apparatus for viewing articles that is capable of conveying the article status to the user.

“Associated assessor” means an assessor that has assessed a particular article.

“Author” means an entity that has created an article.

“Assessor” means an entity that vouches for the article status of an article other than unknown.

“Assessor Account” means a data object that contains identifying information about an Assessor.

“Assessed article” means an article which has been assessed by an assessor.

“Assessment attributes” means characteristics of the assessor.

“Assessment database” means a database containing assessment attributes, URIs, and their associations.

“Blockchain” means a digitally distributed, decentralized, public ledger that exists across a network.

“Challenging assessor” means an assessor who challenges the article status of an article.

“Publisher” means an entity that makes an article available for viewing on the Internet.

“Smart Contract” means a program stored on a blockchain that runs when predetermined conditions are met.

“URI” means a uniform resource identifier comprising a string of characters that unambiguously identifies a particular article.

“User” means an Internet user who makes a request to view an article.

In one embodiment of the present invention, there is provided a system and method for associating an endorser with an article on the Internet. Each article is identifiable by its unique URI. A user requests to view an article by providing the URI to an article viewer. When the article viewer accesses a URI, it queries an endorsement database to determine article status. If an endorser has endorsed the article, the article viewer will indicate that the article is trusted. If the article has not been endorsed by an endorser or a URI for the article is not in the endorsement database, the article viewer will indicate that the article status is unknown.

In one embodiment of the present invention, there is provided a system and method for associating an endorser with an article on the Internet. Each article is identifiable by its unique URI. The URI may be a hash of the article, and the article may be stored on a distributed file system such as IPFS. A user requests to view an article by providing the URI to an article viewer. When the article viewer accesses a URI, it queries smart contract on a blockchain for metadata on the article to determine article status. If an endorser has endorsed the article, the article viewer will indicate that the article is trusted. If the article has not been endorsed by an endorser or a URI for the article is not in the endorsement database or retrievable by the smart contract, the article viewer will indicate that the article status is unknown.

In another embodiment of the present invention, the article viewer will also convey endorsement attributes of the endorser of an endorsed article.

The world is awash in information, and much of it should not be trusted for any one of numerous reasons. We describe a system that provides a basis for incremental revisions of articles by a succession of endorsers, each of whom has known and accessible trustworthiness credentials. When an article is shown to be inaccurate, its trustworthiness is deprecated and all articles that depend upon it similarly have their trustworthiness credentials deprecated. When a trusted endorser first provides an endorsement for an article, the article's trustworthiness status becomes trusted. When the article is refuted, the article's trustworthiness status changes to mistrusted. According to a choice of policies, the endorser's trustworthiness status may be reduced from trusted to mistrusted immediately or only after multiple incidents of inaccuracy. In one embodiment of the present invention, every trusted article derives from one or more currently trusted articles (cited supporting articles) and originally has the same trustworthiness status of its endorser.

An article can be composed of multiple articles, some of which are endorsed articles as well. In this case the viewer accesses the endorsement attributes for each endorsed component as well as the overall article. The viewer then displays the selected attributes used for filtering. In one embodiment of the present invention, the viewer shows the TRUSTED or MISTRUSTED attribute for the overall article. The user can request to display this or other attributes for the overall article or any of its components, and can also request to filter retrieval and display to those articles or components that have the attributes of interest.

In one embodiment of the present invention, the system is used to create a trusted article tree, comprising a set of TRUSTED articles, all of which necessarily depend exclusively on TRUSTED supporting articles and have endorsements entirely of TRUSTED endorsers. The entire network of all articles may contain numerous articles whose trustworthiness status is other than TRUSTED, such as MISTRUSTED or UNKNOWN.

An endorser who has been adjudged as having wrongly endorsed incorrect articles a number of times determined by a system policy has its trustworthiness status changed to MISTRUSTED. An endorser is initially given a TRUSTED trustworthiness status when it meets criteria established by some system policy rule. In one embodiment of the present invention, all users who meet conditions on identity and other qualifications are initially considered TRUSTED. In one embodiment of the present invention, any user who is neither TRUSTED nor MISTRUSTED has the trustworthiness status of UNKNOWN.

An article has its trustworthiness status altered from TRUSTED to MISTRUSTED whenever the article is adjudged to be incorrect, according to some external administrative process and policies. For example, when Donald J. Trump became President of the USA on Jan. 20, 2017, all articles that asserted in an unqualified way that Barack Obama was President became incorrect. Such articles would ideally have their trustworthiness status altered at that point from TRUSTED to MISTRUSTED, because those articles all contain or depend upon a now-incorrect assertion. Carrying the example further, in one embodiment of the present invention, the system would notify the endorsers of those articles that their endorsed articles were now mistrusted and ask the endorsers to modify the incorrect articles. In one embodiment of the present invention, failure to correct endorsed articles in a reasonable amount of time, according to some policy rules, would cause the system to deprecate the trustworthiness status of the associated endorsers.

In this way, the system coordinates the activities of Endorsers to continually update the correctness of previously trusted articles and maintains records of the endorsers' trustworthiness. Because the articles generally consist of natural language, at the present time most articles would depend upon humans to read, endorse, and update the articles as required. In contrast with Reason Maintenance systems where machine agents perform all network maintenance, in one embodiment of the present invention, humans perform much or all network maintenance, and the system records their changes in various databases.

In one embodiment of the present invention, articles of science, news, and general knowledge would be recorded in such a network of endorsed articles with known dependencies upon supporting articles, the trustworthiness status of those articles, and the trustworthiness status of the corresponding endorsers. In that way, any interested user could focus on articles of interest and consume only articles of a desired level of trustworthiness. The basis for an article being TRUSTED, in one embodiment of the present invention, depends on it being correct, supported adequately and exclusively by TRUSTED articles, and being endorsed by a TRUSTED endorser. However, different communities can establish their own community trust protocols. These specify the process each community agrees to use to determine what is TRUSTED and when and how to change that determination.

As an example, if we wanted to replace Wikipedia with a web-accessible trusted article tree, we would specify how to determine the trustworthiness status of every author or endorser, the processes for endorsing an article as TRUSTED and challenging the TRUSTED trustworthiness status of an article or endorser, and the processes for adjudicating such challenges. There are many ways to do this. In one embodiment of the present invention, a three-strike rule for the trustworthiness status of people is implemented: If adjudicators determine that an author/endorser/challenger loses three challenges, that author/endorser/challenger's trustworthiness status is changed to MISTRUSTED.

No circularity can exist among any network of TRUSTED articles, because that would mean an article logically depends on itself. Such tautologies do not adequately justify any of the circularly connected articles. Therefore, all appropriately TRUSTED articles constitute a tree. And we refer to this tree as the trusted article tree.

Because the Articles will most likely be accessed by computers over the Internet, in one embodiment of the present invention, each Article is in the form of an object, with various facets or attributes, each effectively answering one type of question or, equivalently, computing one type of function. Examples of the types of facets that could be incorporated in an embodiment include: Endorser, Date of Endorsement, URI for Article, Original Hash-signature of Article, Current Hash-signature of Article, List of Most Frequent Questions Answered by Article, List of Most Frequent Questions Article Raises, Cited Supporting Articles, Trustworthiness Status of Article, and Justification of Trustworthiness Status. The Original Hash-signature of Article records a key computed from the Article found at the URI when the article was endorsed. The Current Hash-Signature of Article determines the value of that key for the Article at the URI. Any difference indicates that the endorsed article has been changed and should no longer be considered TRUSTED. Absent any other information, in one embodiment of the present invention, the Trustworthiness Status of Article is changed to MISTRUSTED, reflecting that it has no current valid Endorsement. In one embodiment of the present invention, a note is added to Justification of Trustworthiness Status indicating that the article was changed after its original endorsement. In one embodiment of the present invention, the Endorser is notified of these decisions.

Trusted article trees with their multi-faceted objects make possible numerous advantages compared to other knowledge collections. First, all objects have a justified trustworthiness status. The community of participants specifies the process for establishing and maintaining trustworthiness status assessments, and this increases community faith that the assessments are appropriate. Moreover, the trees provide a natural path for supporting discovery and learning. With a simple software program, a user can start a search with a question in mind, then search for objects whose attribute declares they answer that question best. After displaying the article to the user, the program can suggest the user identify which of the most likely subsequent questions to follow next and automatically jump to the object that best answers the chosen question. This is like “flying a route” in map software, but here the learner is being guided from object to object based on a pedagogical rule: someone asking a question should be given the best answer and then invited to follow automatically to the object that best answers the questions most often raised by that answer. Trusted article trees can be searched manually, automatically, or in a mixed-initiative way according to pedagogical rules. This makes them ideally suited for representing knowledge and helping others browse it and grasp it.

In one embodiment of the present invention, a device with one or more memories and one or more processors is configured to establish an assessor account for an assessor in an assessment database. This assessor account comprises assessment attributes of an assessor. The device further establishes an article record for an article in a smart contract on a blockchain. The article record can include a URI, an article status from the assessor, and an association of said article record to said assessor account. The device can respond to a request from an article viewer, such as a web browser, where the request includes a URI, by querying the smart contract on a blockchain, determining if the URI is associated with the article record, and returning to the article viewer a response comprising the article status, such as trusted, mistrusted, or unknown.

In one embodiment of the present invention, a non-transitory computer-readable medium with an executable program stored on it instructs a processor connected to a network to establish an assessor account for an assessor in an assessment database. This assessor account comprises assessment attributes of an assessor. The program further establishes an article record for an article in a smart contract on a blockchain. The article record can include a URI, an article status from the assessor, and an association of said article record to said assessor account. The program can respond to a request from an article viewer, such as a web browser, where the request includes a URI, by querying the smart contract on a blockchain, determining if the URI is associated with the article record, and returning to the article viewer a response comprising the article status, such as trusted, mistrusted, or unknown.

In one embodiment of the present invention, a method for associating endorsers with articles on a blockchain by establishing an assessor account for an assessor in an assessment database. This assessor account comprises assessment attributes of an assessor. The method further includes establishing an article record for an article in a smart contract on a blockchain. The article record can include a URI, an article status from the assessor, and an association of said article record to said assessor account. The method further includes responding to a request from an article viewer, such as a web browser, where the request includes a URI, by querying the smart contract on a blockchain, determining if the URI is associated with the article record, and returning to the article viewer a response comprising the article status, such as trusted, mistrusted, or unknown.

In these embodiments, other variations are possible. In one embodiment, the assessment database is also established as a smart contract on a blockchain. In one embodiment, the article is composed of one or more subparts, and the article record further includes a URI, an association of the article record to the assessor account, and an article status from the assessor for each subpart. In such embodiment, the attributes of interest comprises a filter based on the article status, by querying the smart contract on the blockchain, determining if the URI is associated with the article record, filtering each of the subparts by the attribute of interest and returning to the article viewer a response comprising the article subparts matching the attribute of interest in the request.

In one embodiments of the present invention, the assessor is required to verify its identity. In one embodiments of the present invention, the response returned to the article viewer includes assessment attributes. In one embodiment of the present invention, the article status may be modified in response to a challenge from a challenging assessor who has successfully traversed an adjudication process. In one embodiment of the present invention, the article record may be associated with multiple assessor accounts. In one embodiment of the present invention, the article record may represent a directory of articles.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram of various functional components

FIG. 2 is a flow chart of the initial process.

FIG. 3 is a flow chart of a process.

FIG. 4 is a flow chart of a process.

FIG. 5 is a block diagram of the basic components of the system, including an article, a URI, an endorsement database and a viewer.

FIG. 6 is a block diagram of the basic components of the system, further including compound articles.

FIG. 7 is a block diagram of the basic components of the system, further including cited supporting documents.

FIG. 8 is a block diagram of the basic components of the system, further including citing documents.

FIG. 9 is a flowchart illustrating endorsing and challenging an article.

FIG. 10 is a flowchart illustrating accessing an article.

FIG. 11 is a block diagram of the computing substrate.

### DETAILED DESCRIPTION

Before the invention is described in further detail, it is to be understood that the invention is not limited to the particular embodiments described, as such may, of course, vary. It is also to be understood that the terminology used herein is for the purpose of describing particular embodiments only, and not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed with the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, if dates of publication are provided, they may be different from the actual publication dates and may need to be confirmed independently.

We describe a system that enables users to easily determine whether an article can be trusted by conveying to the user whether the article has been endorsed by an endorser. A further embodiment of the present invention provides the user with endorsement attributes. Examples of endorsement attributes may include name, profession, employer, reputation, identification, qualification, and history of the endorser. This allows a user to see who has endorsed an article and determine whether that endorser should be trusted.

An assessment database is used to record the associations between an article record, including a URI, and its assessor (which may be one or more assessors). The assessment database also records associations between the assessor and the attributes about that assessor that the article viewer can respond to. In the simplest case, there is only one assessor and the only attribute considered is whether the assessor is TRUSTED or MISTRUSTED. In this case, the article viewer shows the article and prominently displays TRUSTED or MISTRUSTED accordingly. In other cases, the user can request to filter out presentation of any article or portion of an article that has particular assessor attributes, such as MISTRUSTED.

An article can be composed of multiple articles, some of which are assessed articles as well. In this case, the article viewer accesses the assessment attributes for each assessed component as well as the overall article. The article viewer then displays the selected assessment attributes used for filtering. In the default case, the article viewer shows the TRUSTED or MISTRUSTED attribute for the overall article. The user can request to display this or other attributes for the overall article or any of its components, and can also request to filter retrieval and display to those articles or components that have the attributes of interest.

Accordingly, this invention provides a layer of information about the trustworthiness of articles and sources and filtering mechanisms sensitive to that information that enable consumers to find articles from trusted sources efficiently.

In some embodiments, the assessor informs the system that an entire directory should be considered TRUSTED. In this case, every article retrieved from that directory is viewed as TRUSTED. The assessor can indicate whether articles in all of that directory's subdirectories, if any, should be considered TRUSTED, or whether only those in the named TRUSTED directory itself should be TRUSTED.

This system can also maintain a reputation object about each known party. The party may be an author, publisher, assessor, user or challenging assessor of an article. The reputation object records some or all data pertinent to a party's reputation, including what identification materials were used to vouch for the party's online credentials and the process or service used to validate those materials and the process or service used to verify the party's online credentials. In addition, the system can maintain a history of the articles the party has authored, published, assessed, justified, accessed, and challenged. A party can justify an article by providing evidence for some of its assertions. A party can challenge an article by providing evidence refuting or undercutting some of its assertions. In a system context where adjudicators are called upon to assess evidence, the reputation object should also record the outcome of such adjudications. This makes it possible for reputations to be enhanced by supporting adjudications or deprecated in response to adverse adjudications. For example, the reputation of an author should be enhanced when a challenge to the author's evidence is rejected. The reputation of a party whose challenge to an article's veracity is upheld by adjudication should likewise be enhanced. Reputations can also be associated with articles, as with parties who author, publish, assess, justify and access articles.

In some environments, reputations are stored in a secure database. In one preferred implementation, reputations are recorded using a blockchain, making possible a complete chronological record of all transactions related to articles and parties. This would provide maximum information about reputations that could be supplied to people or programs that need it. In other embodiments, the reputations may be provided by distributed services called upon to supply or vouch for an assessor's credentials. A plurality of such services might be employed, so that the reputations are available through a federation of reputation services. This has the advantage of enabling a variety of identity authenticators to provide and support reputations.

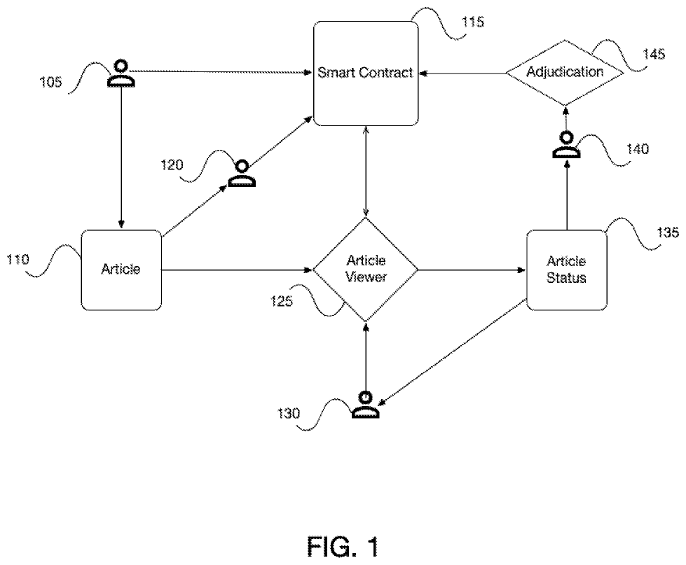

Turning now to FIG. 1, shown is a block diagram of an embodiment of the present invention. An author 105 creates an article 110 which is made publicly available, such as posting on a public network such as the internet. A hash is made of the article, for example using SHA256, and that hash can be used as a URI for the article 110, which can lodged in an smart contract 115. For example, if the article is hashed and stored on a decentralized storage system such as IPFS, the hash of the article is the URI used for retrieving the article. Associated with the URI of the article 110 in the smart contract is an article status 135. If there is no article status associated with the article 110, then the system will set the article status 135 to UNKNOWN. An assessor 120 can assess an article 110 and make a determination of the article status 135 as TRUSTED or MISTRUSTED, and the system can associate that article status 135 with the article 110 in the smart contract 115. A user 130 who wishes to view an article 110 along with an indication of its trustworthiness can access the system with an article viewer 125. In one embodiment of the present invention, the article viewer 125 can be a browser plug-in, which can be downloaded and installed into common web browsers such as Google Chrome, Apple Safari, and Mozilla Firefox. When a user 130 accesses the system by requesting an article 110, the article viewer 125 retrieves the article 110 by accessing the URI for the article 110. The article viewer 125 also forwards the URI for the article 110 to the smart contract 115. The smart contract 115 looks up the association of the URI to the network status 135, and returns the article status 135 to the article viewer 125. If the article 110 does not have a URI lodged in the smart contract 115, then the article status 135 returned is UNKNOWN. If there is an article status associated with the URI, then the article status 135 will be either TRUSTED or MISTRUSTED. When the article viewer 125 presents the article 110 to the user 130, the article viewer 125 also presents the article status 135. In one embodiment of the present invention, the article status 135 is presented as an icon embedded in, or overlaid on, the article 110.

The following is Solidity code for a smart contract to establish the data structure and set the article record on the Ethereum blockchain:

```
contract Proof {
  struct ArticleDetails
  {
    uint timestamp;
    string assessor;
    string articleStatus;
  }
  mapping (string => ArticleDetails) files;
  event logFileAddedStatus(bool status, uint timestamp, string assessor,
  string articleStatus, string articleHash);
  function set(string memory assessor, string memory articleStatus, string
  memory articleHash) public
  {
    if(files[articleHash].timestamp == 0)
  {
    files[articleHash] = ArticleDetails(block.timestamp, assessor,
    articleStatus);
    emit logFileAddedStatus(true, block.timestamp, assessor,
    articleStatus, articleHash);
  }
  else
  {
    emit logFileAddedStatus(false, block.timestamp, assessor,
    articleStatus, articleHash);
  }
}
```

Following is Solidity code for a function in a smart contract to retrieve the article record from the blockchain.

```
function get(string memory articleHash) public view returns (uint
timestamp, string memory assessor, string memory articleStatus)
{
  return (files[articleHash].timestamp, files[articleHash].assessor,
  files[articleHash].articleStatus);
}
```

Continuing with FIG. 1, the system may also accept a challenge from a challenging assessor 140. If a challenging assessor 140 has evidence that an article status 135 for an article 110 is incorrect, the system may accept the evidence from the challenging assessor 140. The system's adjudication process 145 makes a determination as to whether the evidence presented by the challenging assessor 145 is persuasive, and if so, updates the article status 135 in the smart contract 115.

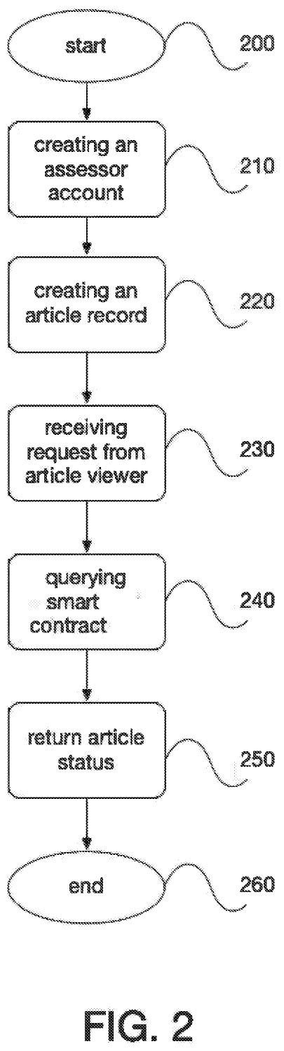

Turning now to FIG. 2, shown is the initial process of one embodiment of the present invention. The process starts 200 with the system creating an assessor account 210 that contains assessment attributes stored in an assessment database. The next step is creating an article record 220 for an article, wherein the article record contains an URI for an article, an article status, and an association to the assessor account of the assessor who assessed the article. The system is capable of receiving requests from an article viewer 230 which contain a URI to an article, then querying the smart contract 240 and retrieving the article status, and optionally, the assessment attributes of the assessor from the assessment database, and returning the article status 250 to the article viewer for presentation to a user and ending the process 260.

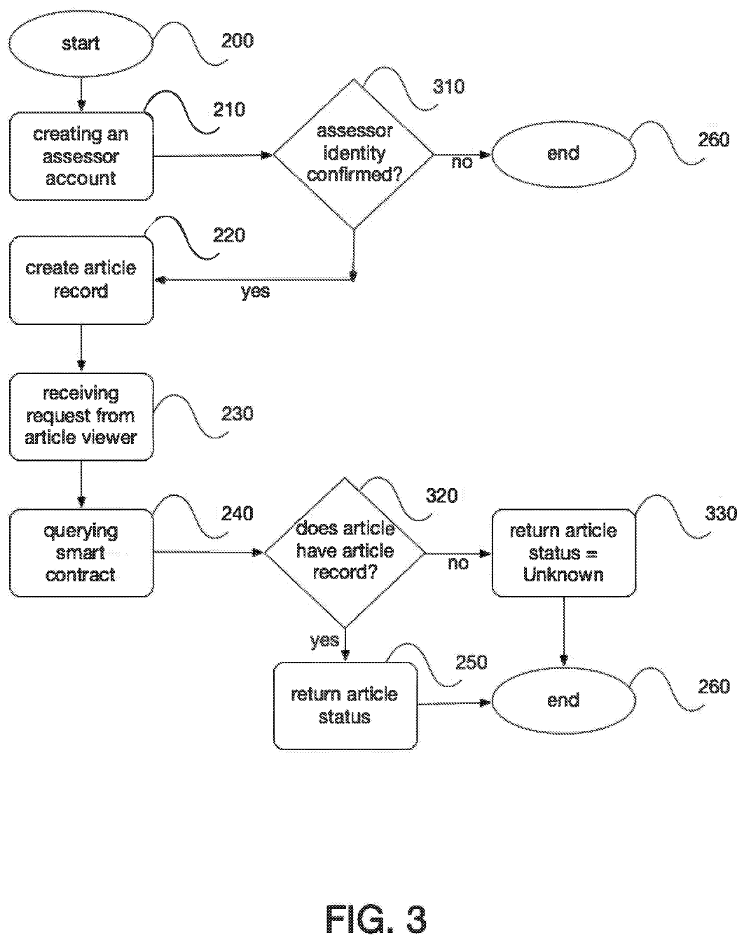

Turning now to FIG. 3, shown is a process of another embodiment of the present invention comprising starting 200 with the system creating an assessor account 210 which contains assessment attributes which are stored in an assessment database and then confirming the identity of the assessor 310. Failing to confirm the identity of the assessor terminates the process 260, otherwise the next step is creating an article record 220 for an article, wherein the article record contains an URI for an article, an article status, and an association to the assessor account of the assessor who assessed the article in a smart contract. The system is capable of receiving requests from an article viewer 230 which contain a URI to an article, then querying the smart contract 240 to determine if an article record exists and is associated with the URI 320. If no article record is associated with the URI, returning an article status of UNKNOWN 330, otherwise retrieving the article status, and optionally, the assessment attributes of the assessor from the assessment database, and returning the article status 250 to the article viewer for presentation to a user and ending the process 260.

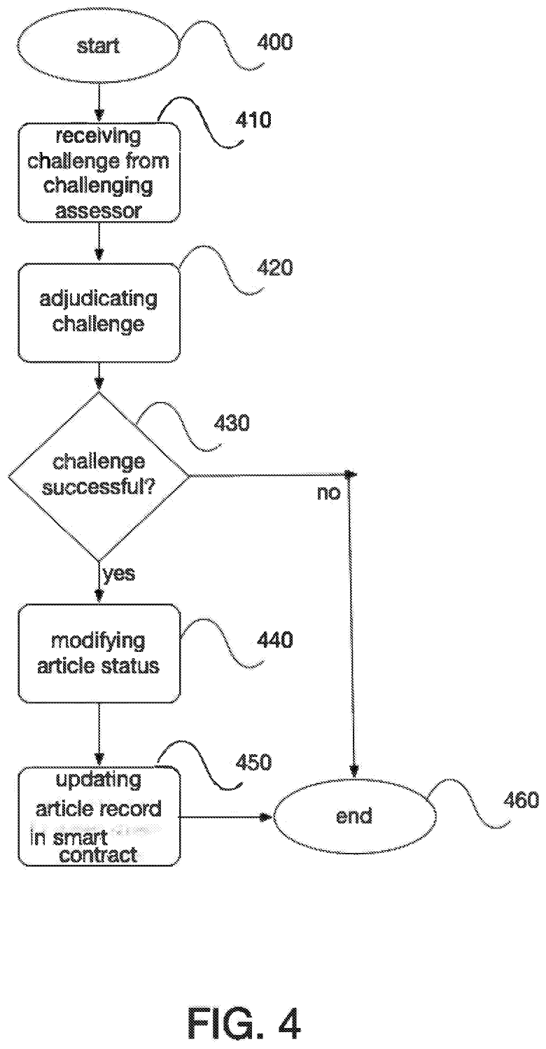

Turning now to FIG. 4, shown is a flow chart of another process of the present invention starting 400 with receiving a challenge from a challenging assessor 410 wherein the challenging assessor is presenting evidence that the article status of an article in the smart contract is incorrect, adjudicating the challenge 420 by determining whether the evidence presented by the challenging assessor is persuasive 430. If the evidence is not persuasive, terminating the process, otherwise updating the article status 440 and modifying the article record in the smart contract 450 and modifying the assessment attributes of the assessor in the assessment database and ending the process 460.

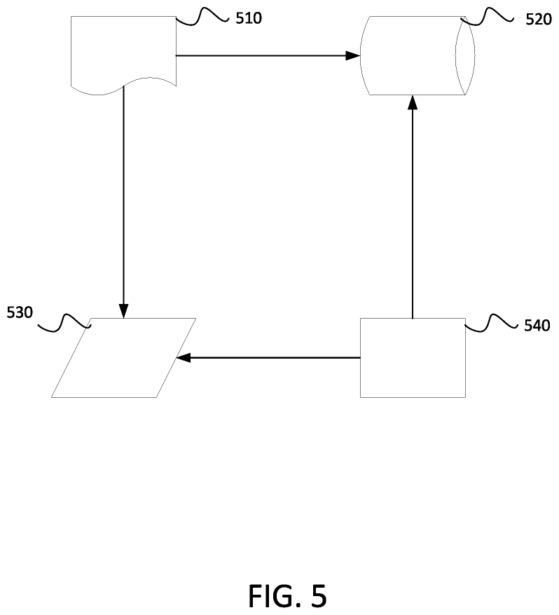

In FIG. 5, the basic elements of the system are shown. An article 510 is associated with an entry in a smart contract 520, which is used to record the associations between an article's locator 530 (e.g., a URI) and its endorser. The article 510 can be a file accessible over a network and locatable by the URI 530. An endorsement database also records associations between an endorser and the attributes about that endorser that the viewer 540 can respond to. The endorsement database can be a flat file, relational database or graph database, or another smart contract. In one embodiment of the present invention, the viewer 540 is implemented as a stand-alone software program. In one embodiment of the present invention, the viewer 540 is implemented as a web-based application. In one embodiment of the present invention, the viewer 540 is implemented as a mobile application. In a simple case, there is only one endorser and the only attribute considered is whether the endorser has an endorser status of TRUSTED or MISTRUSTED. In this case, the viewer 540 shows the article 110 and prominently displays TRUSTED or MISTRUSTED accordingly. In other cases, the user can request to filter out presentation of any article 510 that has particular endorser attributes, such as MISTRUSTED. An endorser who has been adjudged as having wrongly endorsed incorrect articles 510 a number of times determined by a system policy has its trustworthiness status changed to MISTRUSTED. An endorser is initially given a TRUSTED trustworthiness status when it meets criteria established by some system policy rule. In one embodiment of the present invention, all users who meet conditions on identity and other qualifications are initially considered TRUSTED endorsers. In one embodiment of the present invention, any user who is neither TRUSTED nor MISTRUSTED has the trustworthiness status of UNKNOWN. An article 510 has its trustworthiness article status altered from TRUSTED to MISTRUSTED whenever the article 510 is adjudged to be incorrect, according to some external administrative process and policies. Such articles 510 would ideally have their trustworthiness status altered at that point from TRUSTED to MISTRUSTED in the smart contract 520, because those articles all contain or depend upon a now-incorrect assertion.

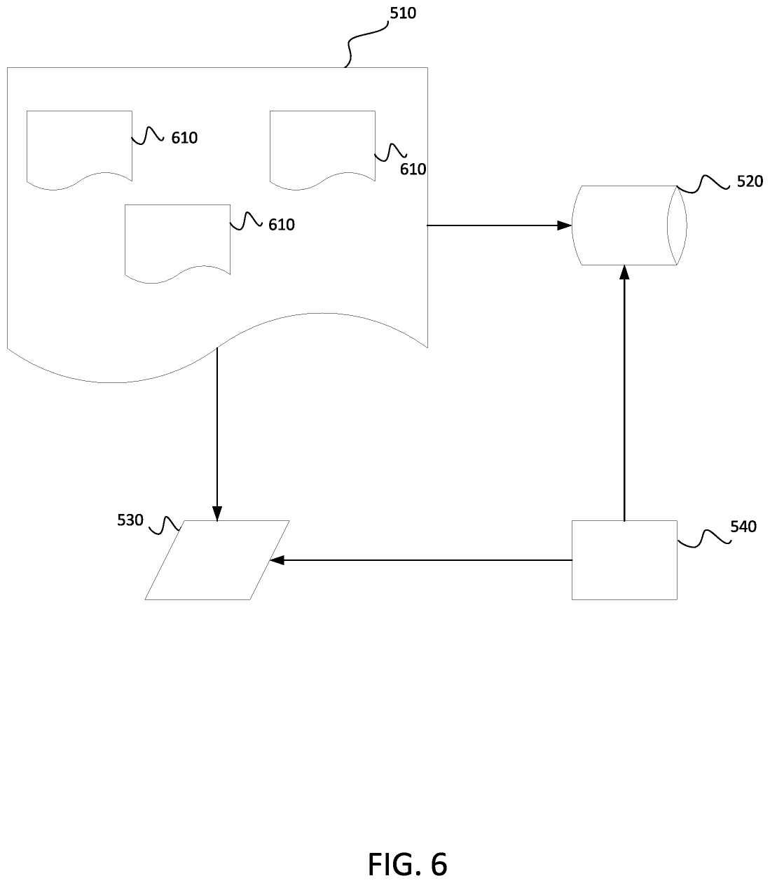

In FIG. 6, the basic elements of the system are shown in which an article 510 may be a compound document comprising a plurality of components 610 which may be individually assessed for trustworthiness in the same manner as an article 510. Each component 610 is associated with an entry in a smart contract 520, which is used to record the associations between an article component's locator 530 (e.g., a URI) and its endorser. The endorsement database also records associations between an endorser and the attributes about that endorser that the viewer 540 can respond to. In a simple case, there is only one endorser and the only attribute considered is whether the endorser has an endorser status of TRUSTED or MISTRUSTED. In this case, the viewer 540 shows the article 510 and prominently displays TRUSTED or MISTRUSTED accordingly and also displays TRUSTED or MISTRUSTED for each component. In other cases, the user can request to filter out presentation of any article 510 or component 610 that has particular endorser attributes, such as MISTRUSTED. Consequently, an article 510 can be composed of multiple articles 610, some of which are endorsed articles as well. In this case the viewer 540 accesses the endorsement attributes for each endorsed component 610 as well as the overall article 510. The viewer 540 then displays the selected attributes used for filtering. In one embodiment of the present invention, the viewer 540 shows the TRUSTED or MISTRUSTED attribute for the overall article 510. The user can request to display this or other attributes for the overall article 510 or any of its components 610, and can also request to filter retrieval and display to those articles 510 or components 610 that have the attributes of interest.

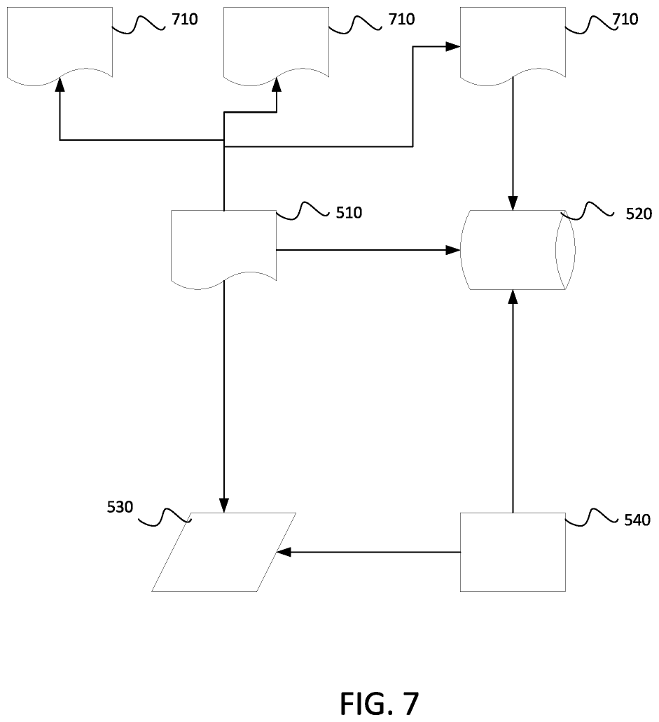

Turning now to FIG. 7, an article 510 may cite supporting articles 710 to support assertions made in the article 510. As with an article 510, a cited supporting article 710 is associated with an entry in a smart contract 120, which is used to record the associations between the cited article's locator 530 and its endorser. The endorsement database records associations between an endorser and the attributes about that endorser that the viewer 540 can respond to. In a simple case, there is only one endorser and the only attribute considered is whether the endorser has an endorser status of TRUSTED or MISTRUSTED. In this case, the viewer 540 shows the cited supporting article 710 and prominently displays TRUSTED or MISTRUSTED accordingly. In other cases, the user can request to filter out presentation of any cited supporting article 710 that has particular endorser attributes, such as MISTRUSTED.

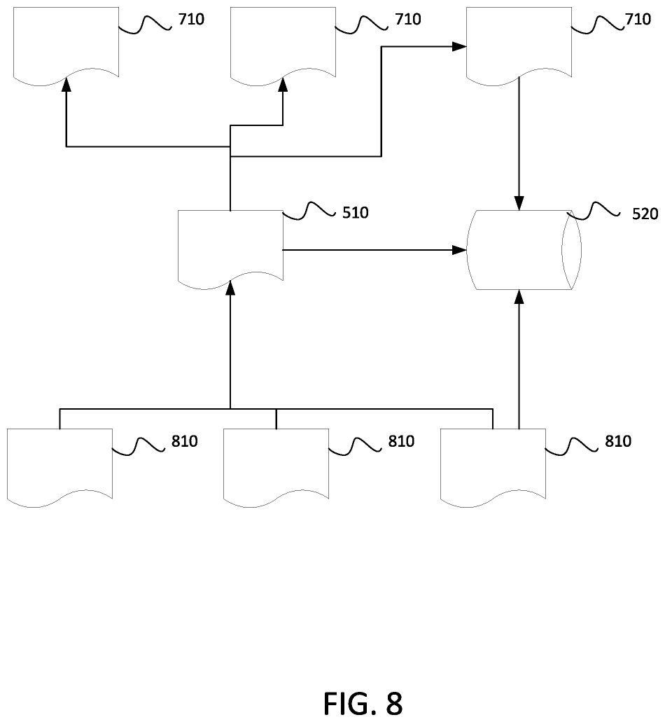

Turning now to FIG. 8, an article 510 may itself be a cited supporting article to other citing articles 810 which cite to article 510 in order to support assertions made in the citing article 810. As with an article 510, a citing article 810 is associated with an entry in an smart contract 520, which is used to record the associations between the cited article's locator 530 (not shown) and its endorser. The endorsement database also records associations between an endorser and the attributes about that endorser that the viewer 540 (not shown) can respond to. As with articles and citing supporting articles, a viewer (not shown) can display the cited article 810 and prominently display TRUSTED or MISTRUSTED accordingly based on its trustworthiness status. In other cases, the user can request to filter out presentation of any citing article 810 that has particular endorser attributes, such as MISTRUSTED.

Continuing with FIG. 8, in this manner, trusted article trees are created wherein trusted articles necessarily depend on trusted cited supporting articles and have endorsements from trusted endorsers. In one embodiment of the present invention, the system is used to create a trusted article tree, comprising a set of TRUSTED articles 510, all of which necessarily depend exclusively on TRUSTED supporting articles 710 and have endorsements entirely of TRUSTED endorsers. The entire network of all articles may contain numerous articles whose trustworthiness status is other than TRUSTED, such as MISTRUSTED or UNKNOWN. Consequently, articles of science, news, and general knowledge would be recorded in a network of endorsed articles 510 with known dependencies upon cited supporting articles 710, and supporting citing articles 810, the trustworthiness status of those articles 510, cited supporting articles 710 and citing articles 810, and the trustworthiness status of the corresponding endorsers. In that way, any interested user could focus on articles 510 of interest and consume only articles 510 of a desired level of trustworthiness. The basis for an article 510 being TRUSTED, in one embodiment of the present invention, depends on it being correct, supported adequately and exclusively by TRUSTED cited supporting articles 710, and being endorsed by a TRUSTED endorser. No circularity can exist among any network of TRUSTED articles 510, cited supporting articles 710 and citing articles 810, because that would mean an article 510 logically depends on itself. Such tautologies do not adequately justify any of the circularly connected articles. Therefore, all appropriately TRUSTED articles 510 constitute a trusted article tree.

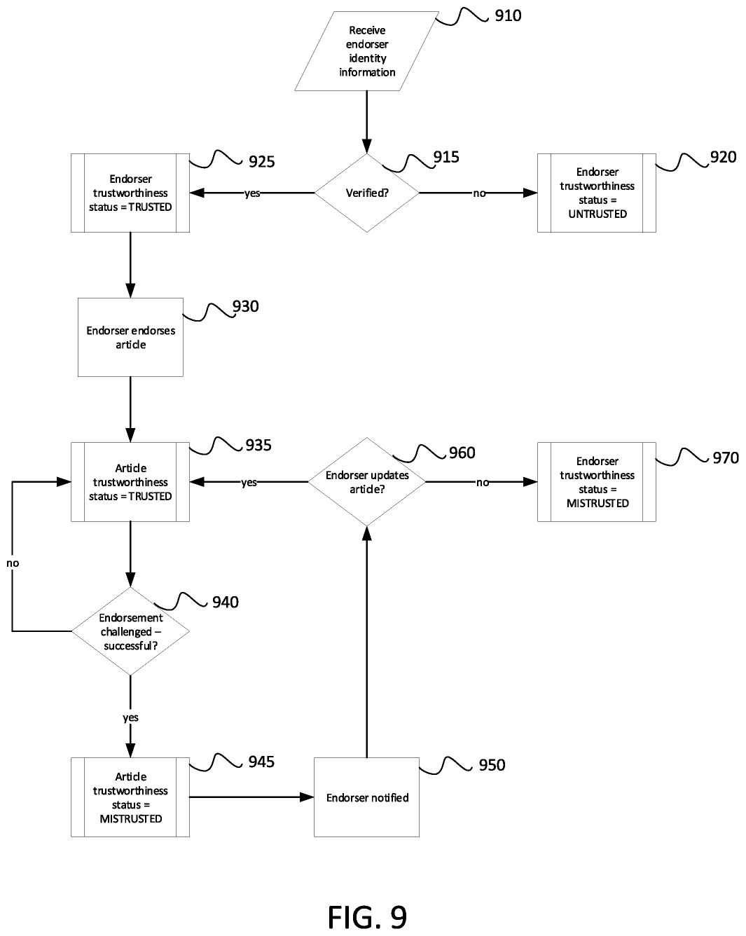

Turning now to FIG. 9, shown is the method for endorsing and challenging an article. To implement a web-accessible trusted article tree, we would specify how to determine the trustworthiness status of every author or endorser, the processes for endorsing an article as TRUSTED and challenging the TRUSTED trustworthiness status of an article or endorser, and the processes for adjudicating such challenges. Starting in block 910, the system receives the identity information of an endorser. In block 915, the system validates the identity information of the endorser. If the endorser's identity information cannot be validated, the endorser's trustworthiness status is entered into the endorsement database as UNKNOWN as shown in block 920. If the endorser's identity is verified, the endorser's trustworthiness status is entered into the endorsement database as TRUSTED as shown in block 925. As an initially TRUSTED endorser, the endorser can endorse an article in block 930. The trustworthiness status of the article will, in block 935, be assigned to the trustworthiness status of the endorser in a smart contract on a blockchain, which in this case is TRUSTED. That endorsement can be challenged as shown in bock 940; if the challenge is not successful, the article will continue to retain a article status of TRUSTED as shown in block 935, ready to take on any subsequent challenges. If the challenge is successful, then in block 945 the article status will be changed to MISTRUSTED in the smart contract. In block 950, the endorser is notified of the results of the challenge by the system, and the system in block 960 monitors to determine if the endorser has made a revision to correct the deficiency that resulted in a successful challenge. In one embodiment of the present invention, failure to correct the deficiency will result in the endorser endorsement attribute to be changed to MISTRUSTED in the endorsement database, as shown in block 970. In one embodiment of the present invention, a three-strike rule for the trustworthiness status of endorser is implemented: If adjudicators determine that an author/endorser/challenger loses three challenges, that author/endorser/challenger's trustworthiness status is changed to MISTRUSTED. If the system determines that the endorser has rectified the deficiency, then the article status will be changed to TRUSTED in the smart contract as shown in block 935, and will stand ready to take on any subsequent challenges. In this way, the system coordinates the activities of endorsers to continually update the correctness of previously trusted articles and maintains records of the endorsers' trustworthiness. In one embodiment of the present invention, the system would notify the endorsers of those articles that their endorsed articles were now mistrusted and ask the endorsers to modify the incorrect articles. In one embodiment of the present invention, failure to correct endorsed articles in a reasonable amount of time, according to some policy rules, would cause the system to deprecate the trustworthiness status of the associated endorsers.

In one embodiment of the present invention, each article is in the form of an object, with various facets or attributes. Examples of the types of facets that could be incorporated in an embodiment include: Endorser, Date of Endorsement, URI for Article, Original Hash-signature of Article, Current Hash-signature of Article, List of Most Frequent Questions Answered by Article, List of Most Frequent Questions Article Raises, Cited Supporting Articles, Trustworthiness Status of Article, and Justification of Trustworthiness Status. The Original Hash-signature of Article records a key computed from the Article found at the URI when the article was endorsed. The Current Hash-Signature of Article determines the value of that key for the Article at the URI. Any difference indicates that the endorsed article has been changed and should no longer be considered TRUSTED. Absent any other information, in one embodiment of the present invention, the Trustworthiness Status of Article is changed to UNKNOWN, reflecting that it has no current valid Endorsement. In one embodiment of the present invention, a note is added to Justification of Trustworthiness Status indicating that the article was changed after its original endorsement. In one embodiment of the present invention, the endorser is notified of these decisions.

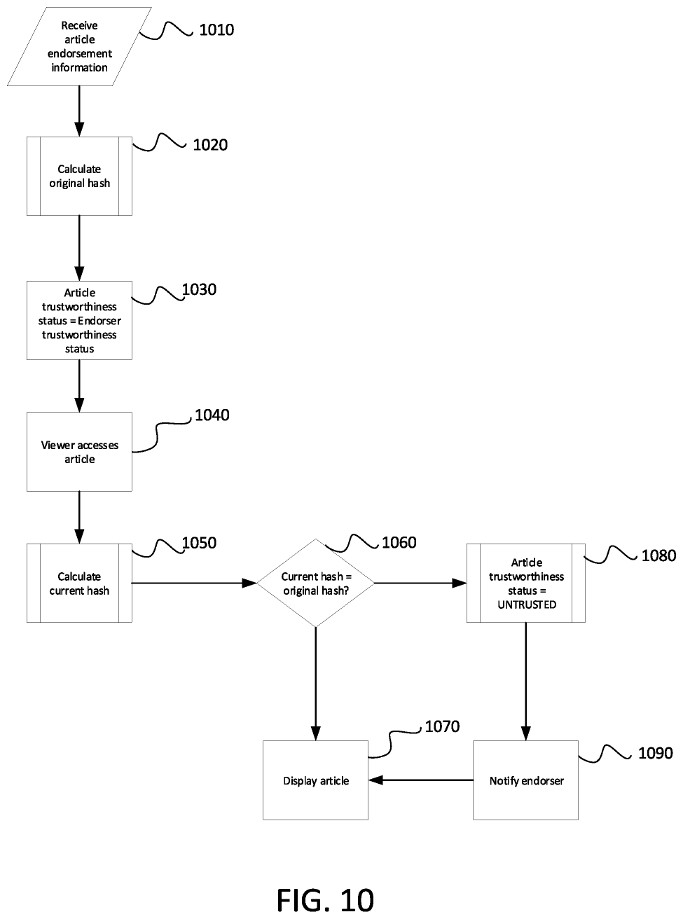

The system processes the endorsement information as shown in FIG. 10. When the system receives article endorsement information as shown in block 1010, the system accesses the article in block 1020 and generates an original hash which is stored in the article record in the smart contract. In block 1030, the article status of the endorsed article is set to the endorsement attribute status of the endorser. In block 1040, when a subsequent user requests an article from the viewer, the system accesses the article at the prescribed URI and calculates a current hash of the article. In block 1060, the system evaluates the current hash with the original hash stored in the smart contract. If the hashes match, the viewer displays the article to the user in block 1070. If the current hash does not match the original hash, then a change has occurred and the system can no longer definitively vouch for the trustworthiness of the article and in block 1080, the article status is changed to UNKNOWN in the endorsement database. In step 1090, the endorser is notified of the action, and the article is then displayed to the user in block 1070 with the updated article status.

Trusted article trees with their multi-faceted objects make possible numerous advantages compared to other knowledge collections. First, all objects have a justified trustworthiness status. The community of participants specifies the process for establishing and maintaining trustworthiness status assessments, and this increases community faith that the assessments are appropriate. Moreover, the trees provide a natural path for supporting discovery and learning. With a simple software program, a user can start a search with a question in mind, then search for objects whose attribute declares they answer that question best. After displaying the article to the user, the program can suggest the user identify which of the most likely subsequent questions to follow next and automatically jump to the object that best answers the chosen question. This is like “flying a route” in map software, but here the learner is being guided from object to object based on a pedagogical rule: someone asking a question should be given the best answer and then invited to follow automatically to the object that best answers the questions most often raised by that answer. Trusted article trees can be searched manually, automatically, or in a mixed-initiative way according to pedagogical rules. This makes them ideally suited for representing knowledge and helping others browse it and grasp it.

As article will generally be accessed by computers over the Internet, in one embodiment of the present invention, each article is in the form of an object, with various facets or attributes, each effectively answering one type of question or, equivalently, computing one type of function. The following is Mathematica code illustrating the attributes of every object [o]:

endorser[o],
endorsementDate[o],
articleURI[o],
article[o]{* file contents of articleURI*},
originaHash[o],
currentHash[o],
questionsAnswered[o],
questionsRaised[o],
citations[o],
trustworthiness[o],
justification[o]

These attributes are available to all software in the same environment, or can be accessed through remote procedure calls with corresponding APIs. A function extracts the article from the object, saves any valid current hash for that article as the previous has value for that article and then computes a current hash value for the article. Then if the current and previous hash values are different, the function changes the trustworthiness status to UNKNOWN and calls a function no notify the endorser appropriately. The best way to implement the notify function depends entirely on the user interface to the endorser and is straightforward for anyone with ordinary programming skills.

In one embodiment of the present invention, a hash of the article is submitted to a blockchain along with the article status and endorser identity. In one embodiment of the present invention, a unique hash is made of the article and a unique hash is made of the article record. Those hashes are then stored on a blockchain. If the authenticity of the article is ever questioned, the off-chain file can be re-hashed at a later time and that hash compared to the on-chain value.

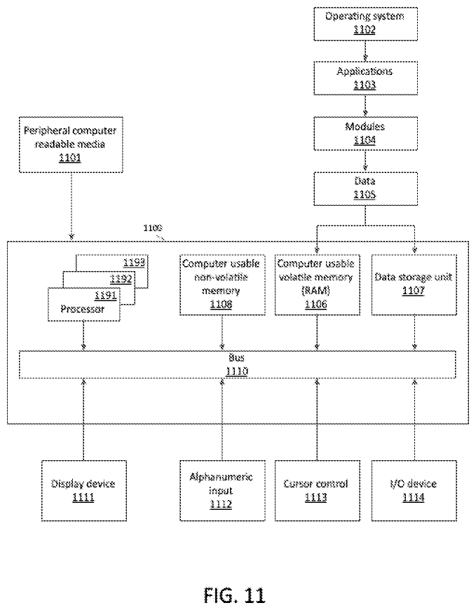

With reference now to FIG. 11, portions of the technology for providing computer-readable and computer-executable instructions that reside, for example, in or on computer-usable media of a computer system. That is, FIG. 11 illustrates one example of a type of computer that can be used to implement one embodiment of the present technology.

Although computer system 1100 of FIG. 11 is an example of one embodiment, the present technology is well suited for operation on or with a number of different computer systems including general purpose networked computer systems, embedded computer systems, routers, switches, server devices, user devices, various intermediate devices/artifacts, standalone computer systems, mobile phones, personal data assistants, and the like.

In one embodiment, computer system 1100 of FIG. 11 includes peripheral computer readable media 1101 such as, for example, a floppy disk, a compact disc, flash drive and the like coupled thereto.

Computer system 1100 of FIG. 11 also includes an address/data bus 1110 for communicating information, and a processor 1191 coupled to bus 1110 for processing information and instructions. In one embodiment, computer system 1100 includes a multi-processor environment in which a plurality of processors 1192, 1193 are present. Conversely, computer system 1100 is also well suited to having a single processor such as, for example, processor 1191. Processors 1191, 1192, 1193 may be any of various types of microprocessors. Computer system 1100 also includes data storage features such as a computer usable volatile memory 1106, e.g. random access memory (RAM), coupled to bus 1110 for storing information and instructions for processors 1191, 1192 and 1193.

Computer system 1100 also includes computer usable non-volatile memory 1108, e.g. read only memory (ROM), coupled to bus 1110 for storing static information and instructions for processors 1191, 1192, 1193. Also present in computer system 1100 is a data storage unit 1107 (e.g., a magnetic or optical disk and disk drive) coupled to bus 1110 for storing information and instructions. Computer system 1100 also includes an optional alpha-numeric input device 1112 including alpha-numeric and function keys coupled to bus 1110 for communicating information and command selections to processor 1191, 1192, 1193. Computer system 1100 also includes an optional cursor control device 1113 coupled to bus 1110 for communicating user input information and command selections to processor 1191 or processors 1191, 1192, 1193. In one embodiment, an optional display device 1111 is coupled to bus 1110 for displaying information.

Referring still to FIG. 11, optional display device 1111 of FIG. 11 may be a liquid crystal device, cathode ray tube, plasma display device or other display device suitable for creating graphic images and alpha-numeric characters recognizable to a user. Optional cursor control device 1113 allows the computer user to dynamically signal the movement of a visible symbol (cursor) on a display screen of display device 1111. Implementations of cursor control device 1113 include a trackball, mouse, touch pad, joystick or special keys on alphanumeric input device 1112 capable of signaling movement of a given direction or manner of displacement. Alternatively, in one embodiment, the cursor can be directed and/or activated via input from alpha-numeric input device 1112 using special keys and key sequence commands or other means such as, for example, voice commands.

Computer system 1100 also includes an I/O device 1114 for coupling computer system 1100 with external entities. In one embodiment, I/O device 1114 is a modem for enabling wired or wireless communications between computer system 1100 and an external network such as, but not limited to, the Internet. Referring still to FIG. 11, various other components are depicted for computer system 1100. Specifically, when present, an operating system 1102, applications 1103, modules 1104, and data 1105 are shown as typically residing in one or some combination of computer usable volatile memory 1106, e.g. random access memory (RAM), and data storage unit 1107. However, in an alternate embodiment, operating system 1102 may be stored in another location such as on a network or on a flash drive. Further, operating system 1102 may be accessed from a remote location via, for example, a coupling to the internet. In one embodiment, the present technology is stored as an application 1103 or module 1104 in memory locations within RAM 1106 and memory areas within data storage unit 1107.

The present technology may be described in the general context of computer-executable instructions stored on computer readable medium that may be executed by a computer. However, one embodiment of the present technology may also utilize a distributed computing environment where tasks are performed remotely by devices linked through a communications network.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer readable storage medium, the computer system performs the methods and processes embodied as data structures and code and stored within the computer-readable storage medium. Furthermore, methods and processes described herein can be included in hardware modules or apparatus. These modules or apparatus may include, but are not limited to, an application-specific integrated circuit (ASIC) chip, a field programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The present invention is embodied in a software application running on a computer. It could be distributed over a network and downloaded on the user's machine, downloaded as a package to be programmatically interfaced by other applications, accessed through a URL as either an API or embedded application, compiled into other applications, downloaded as a stand-alone application, or executed by a computing device that can run the code.

The computer system may be in communication with one or more databases. The one or more databases may utilize any suitable database techniques. For instance, structured query language (SQL) or “NoSQL” database may be utilized for storing the map data, auditory data, user information and the like. Some of the databases may be implemented using various standard datastructures, such as an array, hash, (linked) list, structure, structured text file (e.g., XML), table, JSON, NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

The present technology may be described in the general context of computer-executable instructions stored on computer readable medium that may be executed by a computer. However, one embodiment of the present technology may also utilize a distributed computing environment where tasks are performed remotely by devices linked through a communications network.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A non-transitory computer-readable medium with an executable program stored thereon, wherein the program instructs a processor connected to a network to perform operations comprising:
establishing an assessor account for an assessor in an assessment database, wherein said assessor account comprises assessment attributes of an assessor;
establishing an article record for an article in a smart contract on a blockchain, wherein said article record includes a URI, an article status from said assessor, and an association of said article record to said assessor account;
responding to a request from an article viewer, wherein said request includes said URI, by querying said smart contract on said blockchain, determining if said URI is associated with said article record, and returning to said article viewer a response comprising said article status.

2. The non-transitory computer-readable medium of claim 1 wherein said assessment database comprises a second smart contract on said blockchain.

3. The non-transitory computer-readable medium of claim 1 wherein said article is composed of one or more subparts, and said article record further includes a URI, an association of said article record to said assessor account, and an article status from said assessor for each said subpart, and wherein said attribute of interest comprises a filter based on said article status, by querying said smart contract on said blockchain, determining if said URI is associated with said article record, filtering each of said subparts by said attribute of interest and returning to said article viewer a response comprising said article subparts matching said attribute of interest in said request.

4. The non-transitory computer-readable medium of claim 1 wherein establishing an assessor account includes requiring the assessor to verify said assessor's identity.

5. The non-transitory computer-readable medium of claim 1 wherein said response further includes said assessment attributes.

6. The non-transitory computer-readable medium of claim 1 further comprising modifying said article status in response to a challenge from a challenging assessor wherein said challenge has successfully traversed an adjudication process.

7. The non-transitory computer-readable medium of claim 1 wherein said article record may be associated with a plurality of assessor accounts.

8. The non-transitory computer-readable medium of claim 1 wherein said article record may represent a directory of articles.

9. A device, comprising:
one or more memories; and
one or more processors communicatively coupled to the one or more memories, configured to:
establish an assessor account for an assessor in an assessment database, wherein said assessor account comprises assessment attributes of an assessor;
establish an article record for an article in a smart contract on a blockchain, wherein said article record includes a URI, an article status from said assessor, and an association of said article record to said assessor account;
respond to a request from an article viewer, wherein said request includes said URI, by querying said smart contract on said blockchain, determining if said URI is associated with said article record, and returning to said article viewer a response comprising said article status.

10. The device of claim 9 wherein said assessment database comprises a second smart contract on said blockchain.

11. The device of claim 9 wherein said article is composed of one or more subparts, and said article record further includes a URI, an association of said article record to said assessor account, and an article status from said assessor for each said subpart, and wherein said attribute of interest comprises a filter based on said article status, by querying said smart contract on said blockchain, determining if said URI is associated with said article record, filtering each of said subparts by said attribute of interest and returning to said article viewer a response comprising said article subparts matching said attribute of interest in said request.

12. The device of claim 9 further comprising modifying said article status in response to a challenge from a challenging assessor wherein said challenge has successfully traversed an adjudication process.

13. The device of claim 9 wherein said article record may be associated with a plurality of assessor accounts.

14. The device of claim 9 wherein said article record may represent a directory of articles.

15. A method for associated endorsers with articles on a blockchain, said method comprising:
establishing an assessor account for an assessor in an assessment database, wherein said assessor account comprises assessment attributes of an assessor;
establishing an article record for an article in a smart contract on a blockchain, wherein said article record includes a URI, an article status from said assessor, and an association of said article record to said assessor account;
responding to a request from an article viewer, wherein said request includes said URI, by querying said smart contract on said blockchain, determining if said URI is associated with said article record, and returning to said article viewer a response comprising said article status.

16. The method of claim 15 wherein said assessment database comprises a second smart contract on said blockchain.

17. The method of claim 15 wherein said article is composed of one or more subparts, and said article record further includes a URI, an association of said article record to said assessor account, and an article status from said assessor for each said subpart, and wherein said attribute of interest comprises a filter based on said article status, by querying said smart contract on said blockchain, determining if said URI is associated with said article record, filtering each of said subparts by said attribute of interest and returning to said article viewer a response comprising said article subparts matching said attribute of interest in said request.

18. The method of claim 15 further comprising modifying said article status in response to a challenge from a challenging assessor wherein said challenge has successfully traversed an adjudication process.

19. The method of claim 15 wherein said article record may be associated with a plurality of assessor accounts.

20. The method of claim 15 wherein said article record may represent a directory of articles.
